(19) United States
(12) Patent Application Publication
(10) Pub. No.: US 2015/0098544 A1
(43) Pub. Date: Apr. 9, 2015

(54) Sustainable Modular Transmutation Reactor

(71) Applicant: Anatoly Blanovsky, Los Angeles, CA (US)

(72) Inventor: Anatoly Blanovsky, Los Angeles, CA (US)

(21) Appl. No.: 14/050,265

(22) Filed: Oct. 9, 2013

(51) Int. Cl. G21C 1/28

(52) U.S. Cl. CPC G21C 1/28
USPC 376/246; 376/348

(57) ABSTRACT

A light water reactor to safely convert depleted uranium into a fuel source that could be used as a sustainable source of energy for centuries. The reactor is a type of breed-burn reactor uniquely combined with a proliferation-resistant fuel cycle with no uranium enrichment and no plutonium isolation. It is comprised of a compact factory-produced fast region and a thermal region that produces about 95% of the core power and contains the passageways for transports of delayed-neutron emitters to the fast region, where they can provide additional neutrons (source-based mode) or all the necessary excitation without an external neutron source (self-regulating mode). A second embodiment of the invention is a small unit driven by a neutron source with beam recycling for propulsion, electrical power or radioisotope production. It could also serve as a demonstration facility for the transmutation reactor with fission-fusion fuel.

### CROSS-REFERENCES TO RELATED APPLICATIONS

This application claims the benefit of U.S. Patent Application #20080232533 that has been abandoned because of insufficient funding and Provisional Application Serial No 60/394,071, entitled “Modular Sub-critical Reactor for Nuclear Waste Transmutation Utilizing Proliferation-Resistant Fuel Cycle”, filled on Jul. 8, 2002.

### FEDERALLY SPONSORED RESEARCH

Not applicable

### SEQUENCE LISTING OF PROGRAMS

Not applicable

### FIELD OF THE INVENTION (TECHNICAL FIELD)

This invention relates to a method and an apparatus for nuclear power production, nuclear waste transmutation, isotope production and nuclear propulsion.

### BACKGROUND OF THE INVENTION

At present, the design of nuclear power reactors is based on an earlier military model which does not operate outside of technical constraints imposed by the criticality requirements. It is mainly a pressurized or boiling light water reactor (LWR) or high temperature gas-cooled reactor (HTGR), in which nuclear energy (electrical in nature) is converted to thermal, then to mechanical and finally to electrical energy. To achieve a high degree of burn-up, only fresh low enriched uranium fuel (LEU) or less than 1% the uranium ore energy content is used.

In the current fuel cycle, natural uranium containing seven tenth of a percent of U.sup.235 is enriched to an approximately three percent of U.sup.235 content. It takes about six tons of natural uranium to produce one ton of LEU. About 750,000 tons of the depleted uranium, which already contains about two tenths of a percent of U.sup.235 and could be a major resource of nuclear energy, is now being managed as waste.

A typical fuel assembly remains in the conventional LWR for 3 years to a total burn-up of 30 MWD/kg. A conversion ratio is approximately six tenths of the LEU or less than 7% the fuel assembly nuclear energy is used. The burn-up limitation is mainly because of criticality, but not due to radiation damage to the fuel elements. In addition to U.sup.238 (93%), the spent fuel element contains roughly four percent fission products and two percent fissile material, about half of which is Pu.sup.239 and half is the remaining unburned U.sup.235.

The typical LWR produces about 1200 kg per year of fission products and about 300 kg per year of plutonium, americium and neptunium. The majority of the fission wastes have half-life less than one year. With adequate safeguards, they must be stored for 33 years to reduce the toxicity to 10.sup−10 of their original amount. However, some fission waste products as well as actinides have half-lives greater than one year and need a long-term storage.

The long-term toxicity of spent fuel is dominated by the actinides. Since Tc.sup.99 and I.sup.129 are soluble and can migrate relatively quickly in ground water, they are dominant contributor to the long-term health risk. The burial solution to the long-lived waste problem is based on the assumption that the geological formation will remain stable for the necessary containment period at least 10,000 years. The loss of the large energy content and safety concerns justify needs in transmutation of the nuclear waste.

Several nations have programs to convert the fast breeder for waste transmutation. However, fast reactors have the high cost and long campaign. Significant fissile fuel production could be done in the high conversion LWR that is less expensive and safer than fast reactor. By lower the ratio of the volume of light water to the volume of fuel material in the LWR core from conventional 2.0 to 0.5, one can raise the average energy of neutrons to make the plutonium conversion rate higher than 0.9. Because of the dense lattice construction, this approach has serious problems. The pressure drop in the reactor core becomes about four times as much as that of the conventional LWR, and the unexpected local accidents with coolant loss could lead to the core meltdown.

Also, this method requires raising the enrichment of the LEU to achieve the high degree of the burn-up. As the enrichment increases, the surplus reactivity is large. So a large amount of the burnable poison material has to be put in the reactor at the expense of the neutron economy.

In U.S. Pat. No. 2,992,982 to Avery, a scheme is disclosed for coupling a small thermal reactor region to a fast reactor to enhance the safety of the fast system. Also, U.S. Pat. No. 3,291,694 to Borst discloses an idea for safe controlling reactor neutron output. However, new materials should be developed to solve their difficult corrosion and developed problems.

Since plutonium produces less than half the fraction of delayed neutrons of uranium, the plutonium fuel use essentially reduces safety of the conventional reactors. Other problems involved with the operation of conventional nuclear reactors are the safety of long-term radioactive waste storages, as well as the quickly diminishing worldwide supply of natural uranium ore. Thorium offers important advantages with respect to the uranium-based fuel cycle. Thorium is more abundant, has larger eta and absorption cross-section than uranium. The risk of nuclear proliferation is negligible, since U.sup.233, is present in the fuel as an isotopic mixture, with radioactive U.sup.232 produced by the (n, 2n) reactions. This effect is maximized by fast neutrons, which produce more U.sup.232 than thermal neutrons. The transmutation of the long-lived wastes into short-lived radioactive isotopes can be achieved in sub-critical systems driven by a high-energy proton accelerator.

In high thermal neutron flux the residence time of actinides in the system in equilibrium is long enough for several neutron absorption events on the same nuclide. So some actinides can make fission before they decay. Accelerator transmutation of waste is based on a 1000 m-long proton accelerator with a beam power of about 50 MW that might be difficult to develop into an economical system.

Neither of the designs disclosed in the previous applications such as described in U.S. Pat. Nos. 5,160,196, 5,513,226, 5,949,837, 6,738,446 is truly safe and non-proliferate. Finally, the previous reactor designs are not suitable for consuming large amounts of plutonium and depleted uranium. Thus, neither of the previous designs provides a solution to the stockpiled waste problem. Applicant has discovered through continued research that several changes must be incorporated into the LWR or HTGR design to eliminate the risk associated with critical reactor designs. A solution, which is based essentially on existing nuclear technology, is a sustainable modular reactor (SMR) driven by a small factory-produced booster. In addition to the prime concept, the compact SMR is proposed.

### SUMMARY OF THE INVENTION

The present invention is utilizing nuclear fuel and excited nuclear matter characteristics to improve safety, power density distribution, and neutron economy of a power reactor. A fission reactor can be economical and practical transmutation or propulsion system only if it requires no external control tools, such as neutron absorbing rods.

By replacing the control rods with neutron feedback loops, we can improve safety and perform nuclear waste burning in sub-critical reactors that have primary system size, power density and cost comparable to the commercial reactors. To increase neutron intensity, the SMR is divided into two zones: a booster and a blanket. The blanket symmetrical high thermal neutron flux zones partition the core into several sub-regions with fertile fuel assemblies. The neutron gate separates the booster with plutonium fuel and the multi-region blanket. The absorbing zone with depleted uranium and rare earth elements is a fast neutron multiplier and a strong thermal neutron absorber.

This design permits fast neutrons from the booster flow through the neutron gate to the blanket. Neutrons moving in the reverse direction are moderated and absorbed in the absorber zone. An important aspect of the SMR that could reduce the price and simplify on-site construction is the reactor's modular design. On-line refueling is essential for reactivity and radial power distribution control.

A further significant advantage of the SMR is obtained by providing passageways in the high-flux zones. They provide extensive variety and flexibility of neutron quality in terms of their energy and spatial distributions. If desired, the passageways could be used for the transmutation of long-lived wastes or to heat propellant. In this invention, the reactivity is controlled by the inclusion of fissionable fuel in the burn zones. The amount of fuel is such that the reactor is always sub-critical. A booster neutron multiplication factor is not greater than 0.98 due to small size and large neutron leakage value at the surface. A blanket multiplication factor is not greater than 0.95.

Since prompt neutrons produced in the blanket cannot penetrate into the booster, the feedback value is mainly due to delayed-neutron emitter circulation. If a 3000 MWt blanket has 160 fuel assemblies: 100 assemblies in the epi-thermal zone and 60 assemblies in the thermal zone, a 8-batch fuel management scheme could be adopted by dividing the blanket core into 8 subzones: 5 subzones in the epi-thermal region and 3 subzones in the thermal region. The 20 fresh depleted uranium assemblies are initially loaded into the innermost ring of the epi-thermal core zone. Then they are gradually moved to the outer rings of the cores. At the equilibrium state, a 150 MWt module with the 19.7% enriched uranium fuel is quasi-critical. Since vented fuel qualification would require a long testing and licensing program, an alternative backup approach could be a modified LWR core driven by a small factory-produced high flux module with the low enriched uranium fuel. Plutonium produces significantly fewer delayed neutrons than uranium and its use essentially compromises the safety of conventional critical reactors.

Self-regulating mode represents a core consisting of a critical or quasi-critical module followed by sub-critical sections—energy multipliers. The SMR has sufficient neutron efficiency to operate on many different fuel materials, including thorium, depleted and spent fuel. Also, a fissile metal hydride or ceramic fuel in the form of spheroids can be used to form a core. The present invention provides sub-critical reactors, which can be easily retrofitted into conventional reactor cores. It consumes large quantities of plutonium with depleted uranium or thorium, without generating a lot of waste products. In addition to being able to destroy plutonium, the fission-products having long half-life's can be burned in the high-flux zones of the annular blanket.

As the external supply of neutrons and/or feedback remove the limitations of traditional reactors, more electricity is produced in the SMR from a given quantity of uranium than in a conventional reactor. Additionally, the SMR enables more effective transmutation of nuclear waste than other approaches by utilizing the depleted fuel. It can operate for the life of the plant with addition of only fertile materials. After high burn-up, complete fertile fuel replacement would be performed. It is also possible to replace the damaged sleeves and solid moderator blocks. No chemical separation is needed in a dry low-decontamination mode. The dry mode is proliferation resistant due to the high level of retained activity and heat release that are dominated by Cs.sup.137 and Sr.sup.90. After a few short-term modes with fertile fuel replacement, the next steps are: (a) store the spent fuel for a few years; (b) extract the nuclear waste and actinides from the spent fuel; (c) separate the waste into selected groups and dissolve them as the salts in fuel carriers such as water; (d) finally expose the long-lived wastes and actinides to a high neutron flux. In a preferred embodiment of the present invention, neptunium-plutonium fuel is placed in the booster and the blanket high-flux zones, and fuel with rare earth elements in the absorber zone. The Pu-239 content will be much reduced and plutonium with a high Pu-241 content that has a high value of eta at epithermal energy will be produced.

The delayed-neutron and gamma-ray emitters are continually transported into the booster, where they are is mixed with the booster's Pu.sup.239 fuel. Actinide atoms, primarily plutonium, neptunium, americium and curium, are added to the system as fast as they are destroyed by fission. For that purpose, fissionable fuel supply system has inlet and outlet manifolds and axially extending conduits.

Also, main long-lived fission products (Tc.sup.99, Su.sup.126, I.sup.129) are transmuted by thermal neutron capture to short-lived or stable elements. Gas fission products are removed from the fission fuel and coolant by absorption in the internal separator's activated carbon. Removing gas and volatile precursors of fission products with high thermal cross sections in the internal separators can eliminate xenon oscillations and reduces a neutron poison. Only elements heavier than Xe need probably special removers. Since the transmutation of high level radioactive wastes would be achieved with very high efficiency, it reduces the waste amount and storage time in hundred times, thereby resulting in a significant reduction in long-term waste storage space requirements.

In the SMR, the blanket consists of dozens of LWR or HTGR-type fuel elements each in vertical alignment. Helium, light or heavy water may be used to removing heat. To have an average power density of 300 W/cm³, the 3000 MW(t) blanket volume is about 10⁴ l. The physical dimensions of the blanket region of the SMR may be long enough to accommodate the LWR-type fuel elements. So that spent fuel elements that are temporally stored on the reactor sites would provide the blanket partial loading and can be shifted without any modification to such fuel elements. In the high flux booster driven by the high intensity D-T neutron generator, particulate fuel is packed between porous metal frits, and directly cooled by flowing gas or water. In the 1980s, non-nuclear heated experiments on particulate fuel with large surface-to-volume ratio demonstrated typically 10 MW/L power densities. At the module power density of 2 MW/L and volume of 75 L, a neutron flux in the internal reflector is high. Since the blanket is sub-critical, its control rod material is assumed to be depleted uranium.

The blanket discharge burn-up is estimated using the specific power density and fuel residence time (i.e., 30 MW/t×8 years×90%×365 days/year˜75 GWd/t). Since the scattering cross sections of hydrogen for the fast neutrons are significantly less than for the thermal neutrons, a layer of water backed by a layer of depleted uranium can act as a separator. Preliminary calculations have shown that a water layer about 2 cm thick with about 8 cm thick depleted uranium layer may be used as a one-way reflector between a central module and blanket. In view of this, it is proposed to develop a novel LWR-type breed-burn reactor, which could safely convert depleted uranium or thorium into high energy density fuel. The design, involving a proliferation-resistant fuel cycle without uranium enrichment and plutonium isolation, would avoid keeping the gaseous fission fragments restrained in the fuel elements, an innovative strategy used to monitor and control a coupled fast-thermal reactor. Because the thermal zone is deeply sub-critical, a system can extract a very high percentage of the energy content of its fuel.

Energy utilization of this invention can range from the conventional steam cycle to direct energy conversion. Traditional reactor system can be used to pump water to internal or external steam generators or heat exchangers. In this invention, there is no need in control rods that distort the power distribution. As the fissile concentration of the depleted fuel changes the actinide fuel amount can be also changed. The concentrations of the fissile and fertile materials in the system make a reactor control possible without add burnable poisons to the reactor coolant or fuel. Different amounts of loaded fissile and fertile fuel are used to assure that multiplication factor is always less than one. Also, there are a fuel feed facility for adding fresh fuel along with removing processed fuel, and a gas fission product storage facility located at the upper end of the booster vessel.

### BRIEF DESCRIPTION OF THE DRAWINGS

FIG. 1 is a block diagram of the SMR in accordance with the invention.

FIG. 2 is a horizontal cross-section of the SMR in accordance with the invention.

FIG. 3 is a schematic view of the target-distributed assembly.

FIG. 4 is an example of the medical unit prototype according to the invention.

FIG. 5 is a block diagram of a space SMR in accordance with the invention.

### DETAILED DESCRIPTION OF THE INVENTION

By burning plutonium without compromising reactor safety and requiring fuel reprocessing, the SMR may solve one of the nuclear industry's main problems. With the SMR employment the uranium energy resource can be extended and waste volume can be reduced hundred times the present values. The most effective way of using the SMR would be to burn the actinides in the feedback loops with a gas fission product separated and disposal facility, inlet/outlet manifolds and other means for the fissile fuel feed and processed fuel drain. Fresh fuel is continually fed into the booster at the rate up to 300 g/day (about 100 g/day with conversion factor of 0.8). There is no need for long-lived radioactive materials to leave the reactor site.

Fissionable fuel produced through conversion is consumed in the blanket. The fission fuel inventory of the reactor is quite low. There are also some actinides in well-shielded containers outside of the core. The SMR blanket is a tight light water reactor lattices. At a certain fissile fuel and depleted fuel concentration, the blanket would have multiplication factor of 0.95 up to maximum burn-up. The high neutron flux can be achieved in the blanket that contains a small amount of fissionable fuel and relatively small moderator volume fraction. After fuel has been subjected to a necessary integral neutron flux, remaining unburned plutonium and non-volatile fission products goes back into the containers at the same rate.

After the reactor is shut down, the container is sent to the temporary storage for cooling and further use. Gas or steam inside the loops is pressurized to an operating pressure by a gas or vapor pressure. Although the primary purpose of the loops is to vent fuel, they are used for reactivity and power distribution control. A flow control system for each loop provides predetermined fuel and delayed neutron emitter flow rate. It is optimized to compensate for reactivity variations, to flatten power distribution and to produce a partial isotopic separation of nuclides, including long-lived isomer production. The uranium utilization of the blanket has a high discharge burn-up. There are several operational and material similarities with the SMRs that can be directly applied to the module fuel element and control system design. A fraction of coolant gas is going through particulate fuel to sweep volatile fission products and to enhance the delayed neutron emitter circulation. During the delayed-neutron emitter circulation throughout the booster, they are trapped in the booster. After purification in the gas separator, the purge helium is then returned to the primary loop.

The means by which such elements will be processed is conventional and will not be described herein as outside the scope of this invention. Fertile fuel assemblies can be also coupled to the gas separated facility. Assuming the average delayed neutron fraction of about 0.0015, neutrons are provided by the feedback loops in addition to D-T neutrons. They are multiplied and then moderated in inner reflector to provide a high thermal neutron flux.

### Reactor Core Design

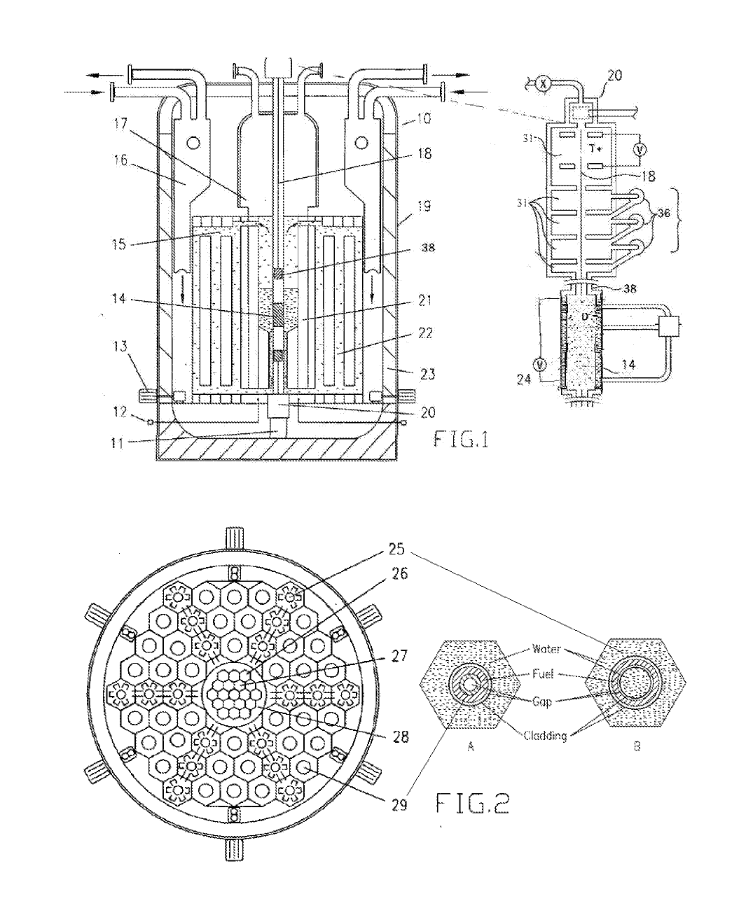

The SMR concept is illustrated by the schematics of FIG. 1 and FIG. 2. The initial design 10 is based on a small LWR, which is now under development at the U.S., or on a Russian LWR known as the VVER-440. The reactor vessel 19 houses a booster 21 with LEU, weapons or reactor-grade plutonium fuel 27, a blanket 22, a feedback loop 15, a thermal shield 23, a thermal neutron absorbing zone 26 and a burn area 28. Fertile fuel assemblies 29 that are containing depleted uranium or thorium fuel surround the moderating zones 25. In FIGS. 2A and 2B, cross-sections of the tube and pellet annular fuel elements that could fit into the VVER or LWR-type fuel assemblies are shown. In order to prevent the loss of neutrons, the internal and outer reflectors surround the booster and the blanket. The neutron reflectors may be heavy water, beryllium or graphite. Neutrons that pass into surrounding reflector are moderated to a thermal temperature. Increasing the loading of fissile fuel in the feedback loops starts up the reactor. After the module is stabilized at a desired power level, the feedback is controlled by the negative temperature coefficient.

Use of a vented fissile fuel permits transport of the delayed neutron and gamma emitters that are not retain in the fuel from the blanket to the booster, where they can provide additional neutrons (source-based mode) or all the necessary excitation without an external neutron source (self-regulating mode).

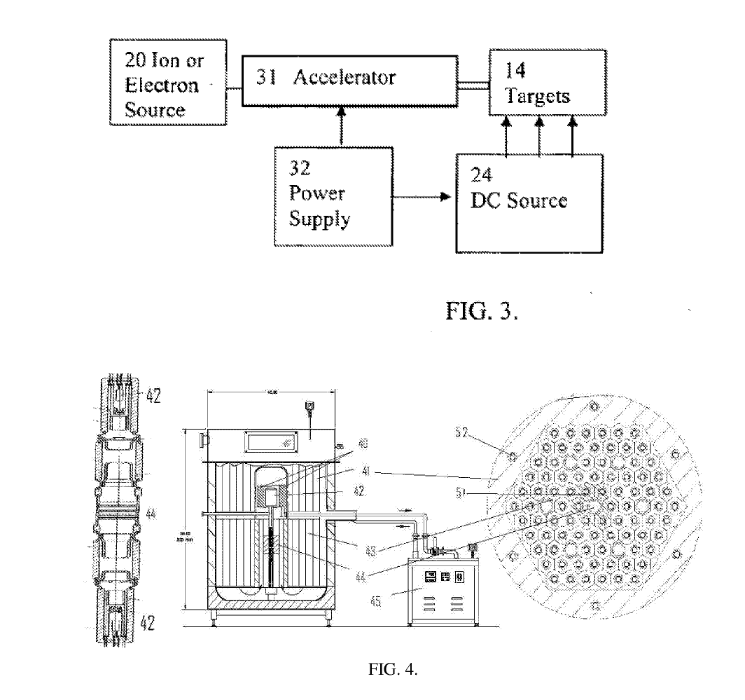

At a steady-state power level, the tritium ion sources 20 with 300 KV accelerator column, a distributed deuterium gas or solid target 14 and high-voltage power supplies of the D-T neutron generators are used to achieve a high neutron yield. See FIG. 3. They control axial power distribution and provide a quick reaction to any fluctuations of the module parameters. Axial power distribution similar to a LWR might be achieved by use the target length comparable with the booster height. Referring to FIG. 1, the SMR includes vertically aligned VVER-type fuel assemblies in a pressure vessel, which is a cylinder with an integral bottom head and a removable upper head. The module in accordance with different embodiments of the invention may include vertically or horizontally aligned fuel elements in the pressured tubes. In order to increase the heat transfer area, different configurations of the fuel assemblies, including ones with directly cooled particle beds, can be used in the booster. The internal steam generators 16 and fission product separation/storage facility 17 are immersed in the pool of reactor coolant, preferably heavy water. The flow in the pool of reactor coolant is produced by pumps 13, which have the drive motors mounted on the outside of the pressure vessel. The pool configuration also eliminates the loss of coolant accidents and piping rupture events. It is also greatly reducing the pressure drop connected with piping losses. The cooling loop contains a steam generator, which drives a steam turbine for electric power generation.

In these applications, the actinides might be in the form of microspheres in a carrier such as water or gas that operates at high temperature without degradation of properties. Design concepts of the fertile fuel assemblies that retrofit into the LWR or HTGR-type cores might be implemented. A research approach that combines the advantages of dispersion and vented fuel forms may lead to the high burn-up fuels needed to close the fuel cycle. The high fertile fuel content led to a high conversion ratio and heat loads.

One concept is based on the modified LWR-type fuel assemblies. The modified LWR design is a class of breed-burn systems in which the blanket core is shuffled. Depleted uranium fuel assemblies are charged into the epi-thermal core zones. As sufficient fissile material is bred in the epi-thermal zone and after the fissile fuel assembly has reached its discharge burn-up, the core is shuffled. In the booster for example containing sand-like particulates, coolant flows through the porous inlet frits, loose fuel beds and exits through the porous outlet frits. The small conducting path together with the good heat transfer reduces the pressure drop of the fertile fuel assemblies in the reactor core. A simple, relatively thin coating is sufficient to retain the non-volatile fission products. In the second concept, the fertile fuel assembly design is based on the fuel particles directly cooled by helium.

By replacing light water with heavy water, we can shift the neutron spectrum to higher energies to efficiently convert depleted uranium or thorium into fissionable nuclei. A preliminary analysis indicates that an average neutron flux 10.sup.15 n/cm²s is achievable in the booster. This flux requires that fuel be changed frequently, i.e. every five or six weeks.

In FIGS. 2A and 2B, cross-sections of the annular fuel elements that could fit into the LWR fuel assemblies or fuel/targets for use with the gas-phase extraction methods are shown. As shown in FIG. 2A, the fuel element is cooled internally by gas or steam and externally by boiling water. Also, the ZrH or BeO layer can be employed in some fuel elements to achieve negative void reactivity. Proposed direct water-cooled fuel will consist of coated depleted uranium oxide kernels embedded in a SiC or BeO matrix to form a spherical pebble. Previous experience with pebble fuels suggests that kernel diameter of 0.7 mm and packing fractions of 0.3 to 0.5 are reasonable. The fuel assembly has an array of cages containing fuel spheres of 5-15 mm diameter, placed inside a prismatic casing.

The SMR digital control system design is largely based on an in-core power monitoring system that was developed for the VVER-440. A prototype of the system with calorimetric gamma-ray detectors, including a signal simulator that used the data downloaded at the power plant was built and many experiments, including a long-lived isomer and fissionable nuclei study, were conducted at the 10 MW research reactor of the Ukrainian Academy of Sciences. The system that was based essentially on commercial software and hardware provided power distribution and reactivity control on the basis of signals from the in-core detectors, including temperature, hydraulic and gamma detectors. Each of instrumentation tubes housed 5 gamma-sensitive elements. The power distribution and thermal state of a core were computed every 10-20 seconds. Multi-channel electronics devices amplified and digitized signals. Off-line calculations were used for real-time synthesis of the signals into 3-D power distribution. The time-dependent power-to-signal conversion factor was determined from the previous values by using a recurrent formula.

The conventional reactors are extremely difficult to control devices. The feedback-type control system response time is faster than response time of neutron consuming control rods. It has self-controlling features and ability to handle large release in reactivity. Also, the control system includes a digital reactivity meter and miniaturized fission chambers 12 for delayed-neutron emitter monitoring. The control system regulates the D-T generators and valves for feeding the booster with fuel, which is housed in the fuel supply system outside the core.

Recently, a tube-in-duct assembly was analyzed. It has the advantage of easy incorporation of a vent path. The fuel can be either “hexnut” shaped beads which slide over the tubes, or spheres which slide down between them. The high burn-up fuel is realized as a thin-coated sphere in high-temperature ceramic materials to help flatten radial power in a way which has constant potency as a function of burn-up. In the case of direct water cooling of the mini-spheres in the blanket and steam superheating in the booster, emphasis is on fuel assembly design modifications which would be relatively easy to retrofit into a LWR-type SMR. In this case, the sheath thickness has a marked effect on the neutron-physics characteristics, particularly the fuel load with TRISO fuel originally developed for HTGR applications with coolant temperatures around 800° C. The PNL study found that the lower coolant temperature of around 300° C. would result in significant irradiation-induced swelling in the SiC coating layer. Two possible solid fuel-recycling techniques are a gas-phase processing approach and a dry technique. The dry technique is perhaps a more proven technology for the oxide fuel.

It allows several cycles of solid fuel burning before going through the reprocessing steps. The uranium and actinide feeds for the SMR are prepared in the primary separator facility by removing the fuel cladding metal and separation of the uranium from actinides by fluorination. After being converted to fluoride salts and dissolved into the liquid medium, the actinides may be further separated from bulk waste containing mostly stable and short-lived nuclei. In a preferred embodiment of the present invention, a Purex process can be used to separate radioisotopes, uranium, plutonium and neptunium, and a Truex process separates americium and curium.

Since rare earth elements are also extracted in the Truex process, a necessary performance can be established with rare earth elements burning in the absorber zone. The water cooler inside the reactor is pressurized to an operating pressure of about 150 atm, and its average operating temperature is about 300.degree. C. The gas coolant removes about 20% of the thermal energy generated in the core. The cooling by the gas and the water increases the plant efficiency. In the typical power modules, the water from the core passes through a steam generator 16. The gaseous circuit includes a steam generator or super heater and compressor housed in the inner vessel.

The equation for the neutron flux N.sub.j in the core is

1.sub.j*dN.sub.j/dt=[k.sub.jj(1−beta.sub.j)−1]N.sub.j+k.sub.ji*(1−beta.sub.i)−1]N.sub.i+k.sub.jj*.SIGM.C.sub.j/.tau..sub.j+k.sub.ji*.SIGMA.C.sub.i/.tau..sub.i+S.sub.j.

Here 1.sub.j is the neutron lifetime, beta.sub.j is the total fraction of delayed neutrons that are emitted following fission, k.sub.jj are coupling coefficients, and C.sub.i is the effective concentration of fission products that emit delayed neutrons of decay time .tau..sub.i. The effective values of the fission product concentrations can be evaluated from the following differential equation dC.sub.i/dt=.beta..sub.i.N.−C.sub.i/.tau..sub.i, where beta..sub.i is the fraction of neutrons with the decay time of tau..sub.i.

The decay lifetimes range from 0.33 sec to 81 sec. For uranium.sup.235 the value of beta is 0.73%. Since for plutonium the value of beta is 0.3%, it makes plutonium burning in the SMR a very important for the future of the nuclear industry. With a few assumptions, the coupled differential equations can be solved analytically in a simple form. If the change in the neutron flux is small, the differential term in the equation can be ignored and the neutron flux approximated by the following equations

beta.sub.j*N.sub.j+k.sub.ji*N.sub.i+S.sub.j=0

beta.sub.i *N.sub.i+k.sub.ij*N.sub.j+S.sub.i=0

It can be shown that the overall gain of the blanket is approximately equal to A/(1−A*k.sub.21), where A=k.sub.12/(1−k.sub.11)(1−k.sub.22).

When the booster is critical, the main effect of the fuel circulation on the core reactivity is in the increasing role of delayed neutrons. For a sphere core with uniform density of sources S.sub.1 and macroscopic absorption cross-sections Σₐ, the average flux is N.sub.1≈S.sub.1/π*(Σₐ+DB²) and the leakage probability is k.sub.12=B²L²/(1+B²L²). Here the buckling is B=π/R and the diffusion mean free path is L²=D/Σₐ.

### Medical and Space Sub-Critical Reactor Design

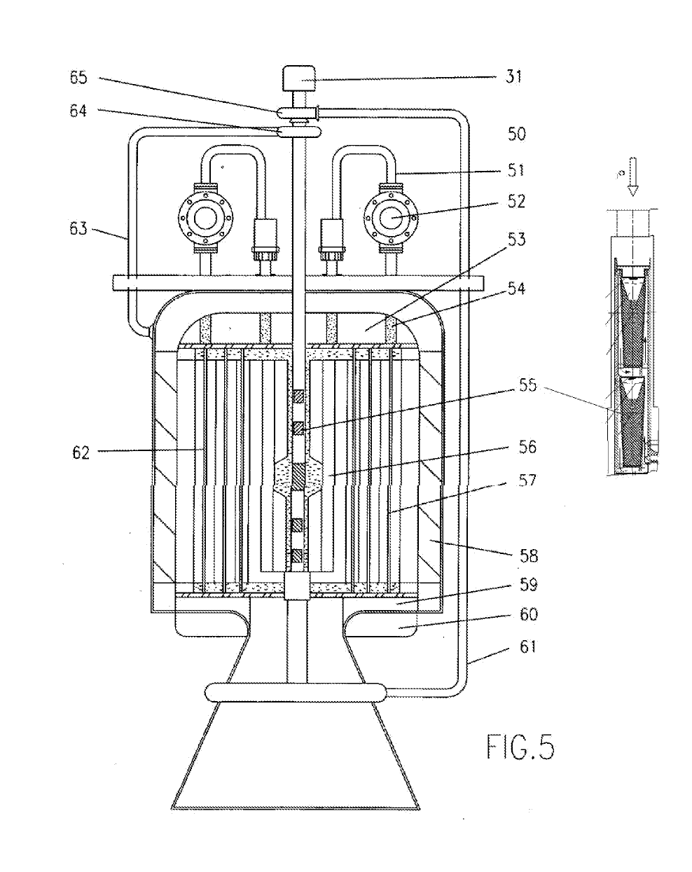

FIG. 4 is showing an illustration example of a medical unit prototype according to the invention. Here 40—gas getters, 41—shielding 42—ion source, 43—core, 44—gas target, 45—purification unit, 51—resonance zone, 52—LEU target, 53—gas cell. A medical unit driven by a D-T neutron source uses a solid molybdenum or low-enriched uranium fuel target for local Mo.sup.99 production. What follows is a very simplistic study of the Mo target that exploits the process called adiabatic resonance crossing. It is assumed that a source of neutrons at energy of about 14 MeV is isotropic and located inside a relatively large lead or carbon block. To estimate this flux in a schematic way, we assume an infinite shielding medium where all fast neutrons that scatter are in equilibrium with thermal absorption. For a sphere with the sources S and radius R, the fast neutron flux at the target is F≈S/4π*R². If R=20 cm and S≈5*10.sup.15 n/s, we have the fast neutron flux F≈10.sup.12 n/s*cm² In this model, the ratio of thermal to fast neutron flux is given by the ratio of scattering and capture cross sections. For graphite it is about 100 and thermal flux will be enhanced to 10.sup.14 n/s*cm².

The most important space nuclear application of this invention is to develop a lightweight sub-critical power and propulsion reactor, which is not radioactive when it is launched. As in the power reactor described above, the main design parameters are the feedback coefficients and ratio of the volume of various moderators to the volume of fuel material in the reactor. Liquid or particulate fuel with helium or mixture of helium and hydrogen coolant is used to generate electrical power (see FIG. 5).

A self-pumped power converter 51 that is thermally coupled to at least one heat pipe 54 might be used in this design. It demonstrates efficient thermo-acoustic production of electrical power using slightly modified commercial hardware (compressor/alternator) 52. For some missions, it is preferred multi-modal operation of the present invention (long-term electrical power/propulsion mode, and high-thrust thermal propulsion mode). In the thermal propulsion mode, heated coolant/propellant can be partially expanded through a gas turbine 64 to drive a gas compressor 65. From the turbine exhaust, the coolant/propellant flows through the nozzle and through the blanket solid moderator containing also channels for the high-thrust thermal propulsion. Liquid hydrogen is used to provide moderate thrust propulsion in an amplifying mode and for high-thrust propulsion in a pulse mode. The absorbing zone 57 that separates the fuel regions may help in maintaining a high gaseous propellant temperature.

Since extra neutrons can be produced with little accompanying radioactive waste, an electron accelerator appears to be the best candidate for the space applications. It offers an approach that can be reached by current commercial technology. Alternatively, a high current auto-accelerator or a wake-field accelerator with internal targets can be used. The electron or D-T TDA 55 with the series and/or parallel-connected high-voltage sections, which may be fission electric cells (FEC), is used in this invention.

The FEC is a high-voltage power source that directly converts the kinetic energy of the fission fragments into electrical potential of about 2 MV. The introduction of gas results in the FEC of higher current at the expense of lower voltage.

Before the module is turned on, the multistage collector is set at a retarding potential by nested capacitors charged inductively or by the electron beam. Partial discharge of the capacitors maintains the retarding voltage in an efficient range. Each FEC has a hollow cathode coated with a thin layer containing a fissionable fuel and anode, nested in a hexagonal moderator. For the U.sup.235 fuel thickness of 1.5 μm, the fission fragment current is about 0.5 μA/g. It is much higher for fission isomers such as Am.sup.242 m. The delayed-neutron emitters that are fed into the cathode through a ceramic tube deliver the desired feedback to the FEC. A multi-stage charged particle collector (anode) of the FEC is composed of thin high-Z material such as tantalum. With a two-stage collector, the second collector is made opaque to the fission fragments while essentially transparent to high-energy electrons. The first collector made of the thin metal ribbons has a high transparency to the incoming fission fragments but it is opaque to the fragments that are turned around.

Since electrons are emitted predominantly from high-Z material and captured in low-Z material (aluminum, beryllium), this technique delivers the highest efficiency. To prevent direct flow of electrons across the gap between the electrodes, self-biased grids surround the cathodes. The charge deposited by the electron beam in the target is used to establish the bias potential at the current carrying grid. As it is known in the intermediate velocity region, the stopping power is slightly increased, when the charge state of ions increases. To maximize the field strength at the cathode, the possible choices for the FEC cathode materials are polymers doped with alkali metals or materials with strong covalent bonds between atoms, but with weak van der Waals interactions between the sheets.

In order to produce thrust, the last section of the FEC array is modified to accelerate inert gas. Such thrusters are described in U.S. Pat. No. 6,449,941.

Referring to FIG. 5 for a space reactor design, a beam tube, which houses a target assembly, passes through the central column. The booster that is formed from refractory material such as fissionable carbide foam or conduits has propellant nozzle at its end. The blanket includes a plurality of hexagonal moderator sections with bores extending along the length of the core. The graphite, lithium and beryllium hydride can be used as a moderator. A general configuration for a SMR 50 is shown in FIG. 5. The rocket 50 includes tank pressurization lines 61, hydrogen propellant heating channels 62, and liquid hydrogen propellant feed tanks 60. Also shown are an extendable nozzle and a throat. In the case of hydrogen as a propellant, hydrogen at different fuel temperature might be used to moderate the neutrons and to control reactivity during the pulse mode. In some applications of the space SMR, the propellant tank pressure forcing the hydrogen propellant through the engine without the benefit of pumps.

During thermal propulsion, gas propellant flows into nozzle torus and then into pressure vessel at inlet plenum 59. Inlet plenum directs it for cooling the blanket, reflector and other associated equipment and then into outlet plenum 53 that directs it out through axial bores of the reactor. If the insertion of hydrogen propellant into the reactor increases, it could become a dumped oscillator. It controlled by an external neutron source rate and by a residence time of delayed neutrons in the booster. For analyzing such problems, it is convenient to use the Bogolubov-Mitrpolsky method.

It enables not only study the stationary state but also to analyze the system dynamics. This method can be also used to examine the interesting phenomena of increasing the reactor fuel element's mechanical stability with high frequency forced vibration.

### Self-Powered TDA for Space and Medical Applications

In the conventional neutron source, the neutron yield Y per charged particle is approximately Y(E)=R(E)/L(E), where range R is the distance the particle travels until its energy reaches reaction threshold energy Ei.

Here L=1/Nσ is the neutron production mean free path, where N is the number of atoms per cubic centimeter and σ is the macroscopic cross section in barn. If the external electric field acts counter to the stopping power in the target or between the thin targets, we have more uniform deposition of the power. The neutron yield per particle is approximately Y(E)=d/L(E), where d is the target thickness.

For n thin targets, in which the energy loss is regained by the acceleration of the particles between the targets, the total neutron yield per particle is nY. In this case, an external electric field U=(n−1)*(E−Ei) is required. For the gas target the lost energy is W(E)=B(E)p, where p is the pressure in mm Hg and B is known from experiment. Since N=7.1*10¹⁶p for two-atom molecules gas, we have L=1.4*10.sup.7/pσ and U=Bpd. While D-D, p-T, p-Li monotonically increases with energy, the D-T reaction cross section has a peak and minimum in value B(E)/σ (E)=0.09 at the deuteron energy of 100 keV.

TABLE 1
Characteristics of D-T, D-D, p-T reactions for gas target.

| | | | | | | |
|---|---|---|---|---|---|---|
| E, keV | 50 | 80 | 106 | 120 | 150 | 1000 |
| σ/B (D-T) | 4.48 | 9.61 | 11.2 | 10.4 | 8.6 | 3.52 |
| E, keV | 200 | 300 | 400 | 500 | 1000 | 2500 |
| σ/B (D-D) | .098 | .17 | .22 | .30 | .68 | 1.47 |
| E, keV | 1020 | 1030 | 1040 | 1080 | 1120 | 1160 |
| σ/B (p-T) | | .25 | .526 | .106 | 1.61 | 2.00 |

For Y=10⁻³, it is required about 1.25 MV additional electric field in the tritium gas target (p=100 mm Hg) of about 30 cm long. The field strength is more than 4.5 MV/m. Since the breakdown strength of air at atmospheric pressure is about 3 MV/m, the D-T TDA requires an external magnetic field in the gaseous target to achieve a high neutron yield.

If similarity law could be extra poled to the densities of solids and liquids, that is about 1000 atm, breakdown strength between 10² and 10³ MV/m, should be observed for the condensed phases. The actually measured strength of most insulators is ten to one hundred times smaller than this extrapolated value. When dielectric material fills space between the metal plates connected to a power supply, the potential difference between them remains constant because the charges on the plates increase.

On the other hand, the electrons in dielectric will certainly reduce the Coulomb force between charges. It was proved by Fermi that the energy loss is in dielectric. Then dW/dx=S/k², where k=∈/∈₀. This expression is the same as the ordinary formula when dielectric constant of vacuum is replaced by optical dielectric constant.

This energy must come from the energy stored in a target-capacitor. The rate at which energy is given to charge particles in the target is the product of the force on them and their velocity dW/dt=+zeEv=+(zeV/d)v or dW/dx=+zeV/d, where E=V/d. Equating this to (4) gives S/k²=zeV/d or V=Sd/zek². With these assumptions the additional electric field is less by (k−1)/k² for a material in which the electric field of passing particle is affected by the polarization of substance.

The possible candidate of the target materials is thorium oxide as it has high dielectric constant in optical range of frequency and uranium/plutonium salt in heavy water, which is an electrolyte or highly condensed plasma. The target-distributed assembly constitutes another preferred embodiment of the invention. Now the most used photo-neutron target is a thick tungsten layer followed by a beryllium layer. As the photon yield has maximum at about 0.3-0.5 of the range of electrons in the target material, the target made of thin high-Z layers could essentially maximize neutron yield. The electron TDA has several sections, in which targets are surrounded by cylinder wall, made of special high strength dielectric materials. The beam passes through the targets to produce intense photon pulses.

Each photon production target consists of Ta, W or U foils supported by tube with heavy water cooling. The electron bunches are post accelerated by rings, which are connected to high-voltage sections. The particles of the incident electron beam, for example in the range of 10 to 20 MeV hit a centrally located distributed target with 30 MeV post acceleration.

To produce bremsstruhlung radiation and to trap out secondary particles, about 10% of the axial beam strikes a target made of a thin high-Z metal with a central hole. A fluence of photons initiates a high voltage pulse from the power supply. Since an insulator surrounds the gap region between the sections, a surface breakdown mechanism promises to be an ideal closing switch for the pulse DC source. The electrodes are used to squeeze the charged particle beam into a narrower beam.

Monte Carlo calculations of electron scattering and energy loss in the target were made using MCNPX code. With 10 thin lead targets (0.2 cm), the total neutron yield is about 0.02 at primary electron energy of 18 MeV and 30 MeV post acceleration. An average electron beam current of about 0.05 mA (2.5 kW electron beam power) is required to reach the estimated source strength about 10.sup.12 n/s. The parameter of primary interest is power required to run the electron accelerator. With efficiency 0.25, current 0.05 mA, E=50 MeV required power is about 10 kWe. This additional electricity can be mainly produced in the booster. A beam current of 0.05 mA that loses 25 kW of power requires that the average energy loss of individual electrons in the beam is about 0.5 MeV. The electron beam in each section is therefore a constant velocity beam. Electron beams of 10 MeV using Ta, U or W converters and Be or BeO radiators can be used for neutron production, with efficiencies approaching that of a 100 MeV beam.

Also, a dielectric-wall linear accelerator with Blumlein modules might be used in this invention. Each accelerator cell is electrically equivalent to two radial transmission lines that are filled with different dielectric materials.

The “fast” line is having the lower dielectric constant fill material, and the “slow” line is having the higher dielectric constant fill material. Before firing a shot, both lines are oppositely charged so that there is no net voltage along the inner length of the assembly. After the lines have been fully charged, high voltage is applied by closing switch. Such accelerator is described in U.S. Pat. No. 5,811,944 issued Sep. 22, 1998, and is incorporated herein by reference. It is generally accepted that, for medical purposes, ideal photon beams are those, which are mono-energetic.

At present, synchrotron radiation from an electron storage ring is practically the only source of monochromatic x-rays with intensities that are adequate for medical applications. However, their high cost, large size and low x-ray energies constitute serious limitations. In the TDA based on a laser-ionized gas-filled capacitor array, the frequency and duration of the radiation is controlled by combination of the gas pressure and capacitor spacing. It is simple and relatively low in cost, and can be controlled to produce a variety of radiation waveforms.

Since solid targets are more efficient x-ray source than synchrotron radiation, advances in accelerator technology have increased their attractiveness for medical applications. Low energy accelerators that employ specific reaction for charged and neutral particle production, i.e. p-.sup.11B, D-T are now being considered as a high voltage source. In the D-T neutron source (see FIG. 1), the target chamber 14 may be a cylindrical volume charged with gas, for example deuterium. The tritium gas is circulated in a completely closed loop system to ion sources 20 positioned above and below the target 14.

The design takes into consideration the assumptions that, in electrodynamics, the vector potential is proportional to the scalar potential, particularly the electron TDA design relies on the fact that the electron beam is a relativistic beam. Historically, a long time before quantum mechanics, Lorentz suggested that some disturbances, like waves, could be transmitted with traveling particles through a certain medium without moving it. This approach led to the natural introduction of the group velocity and intensity of de Broglie waves into Maxwell's equations, and could play an essential role in areas as diverse as GPS algorithms and nuclear waste transmutation. At that time, instead of careful analysis of the systematic errors, some scientists chose to postulate constancy of light velocity to explain why the earth appears not to rotate around the sun in the Michelson experiment. Mathematically, it was based on the Lorentz transformation. Since it equally applies to any wave motion, the true anisotropic values of the velocity of light or sound are used in all calculations.

The consequence of this approach is similar to the electromagnetic structure-based accelerator concept that has been analyzed by W. Gai. One of the early assumptions of his theory of dielectric wake-field acceleration was that, in electrodynamics, the vector potential was proportional to the scalar potential. Since H_{θ}=βEᵣ, the net radial force is Fᵣ=e(1−β²)Eᵣ.

Although the invention has been described in detail with particular reference to these preferred embodiments, other embodiments can achieve the same results.

### REFERENCES

1. A. Blanovsky, “A Neutron Amplifier: Prospect for Reactor-Based Nuclear Waste Transmutation”, the ICONE12 proceedings, Washington, 2004, see ICONE12-49346 at www.asmeconferences.org/ICONE12/.
2. C. D. Bowman et al, “Nuclear Energy Generation and Waste Transmutation, NIM A320, p. 336, 1992.
3. A. Blanovsky, “A Classical Field Theory beyond the Standard Model”, in Fundamental Problems of High Energy Physics and Field Theory, ed. by I. Filimonova and V. Petrov, Proceedings of the 22nd Workshop, Protvino, Russia, 1999, pp. 165-177 (see also http://arxiv.org/abs/phyisics/0401017).
4. L. Borst, “The Convergatron, a Neutron Multiplier”, Phys. Rev. 107, #3, p. 909, 1957.
5. A. Blanovsky, “Conceptual Design of a Target-distributed Accelerator for Boron Neutron Capture Therapy,” First International Workshop on Accelerator-based Neutron Sources for BNCT, p. 459, Sep. 11-14, 1994.
6. W. Gai, “Calculation of Longitudinal and Transverse Wake-Field Effects in Dielectric Structures”, proceedings of the Advanced Accelerator Concept Workshop, ed. by C. Joshi, AIP Conf. Proc. 193, New York, pp. 111-116, 1989.
7. Y. Tsoglin and A. Blanovsky, “Reliable In-core Power Monitoring System”, 2012 ANS Winter Meeting, San Diego, November 2012, ANS Transactions, Vol. 107, p 862.
8. R. Avery, Coupled Reactors with Suppressed Feedback, Proceedings of the 2-nd U.N. International Conference, Vol. 12, Geneva, 1958, pp 182-191.
9. A. Blanovsky, “Conceptual Design of Dielectric Accelerating Structures for Intense Neutron and Monochromatic X-ray Sources”, 11 Advanced Accelerator Concepts Workshop, AIP Conference Proceedings, Volume 737; #1, ed. by V. Yakimenko, New York, pp 295-301, 2004.
10. H. Daniel and Yu. Petrov, “Subcritical Fission Reactor Driven by the Low Power Accelerator”, NIM A373, pp. 131-134, 1996.
11. O. Waldmann, “A Permanent-Magnet Microwave Ion Source for a Compact High-Yield Neutron Generator”, Proceedings of the 21st International Conference on the Application of Accelerators, 2010.
12. J P. Sidik et al., Impact of Different Moderator Ratios with Light and Heavy Water Cooled Reactors in Equilibrium States, Ann. Nuclear Energy, 33, 2006, p. 561.
13. C. Rubbia, Resonance Enhanced Neutron Capture for Element Activation and Waste Transmutation, CERN/LHC/97-04(EET), Jun. 22, 1997.
14. A. Blanovsky, “Radioisotope Production Technology Demonstration Unit”, 2012 ANS Winter Meeting, San Diego, November 2012, ANS Transactions, Vol. 107, p. 97.
15. A. Hershcovitch et al., Energy Efficient Neutron Source: Enabling Technology for Various Applications, DPP09 American Nuclear Society Meeting, 2009.
16. A. Blanovsky, Model Based Breed-Burn Reactor, American Nuclear Society Meeting, San Diego, Calif., Jun. 14-17, 2010, ANS Transactions, Vol. 102, p. 873.

What I claim as my invention is:

1. A nuclear reactor having at least two coaxial fuel regions formed from a hot essentially stationary mass of the fissionable fuel in a proliferation resistant form:
(a) a central fast-spectrum core region,
(b) an annular thermal spectrum core region with fertile fuel such as depleted uranium or thorium and moderator such as water or graphite,
(c) a neutron gate comprises of moderating and thermal neutron absorbing layers that are separating said core regions.

2. The reactor of claim 1 wherein said outer core region has a plurality of modified light water, high temperature gas-cooled or research reactor fuel assemblies containing clad or unclad fertile fuel pellets and means for charging and discharging said fertile fuel, and further comprised of
several symmetrical regions lying in a radial pattern wherein said regions contain the passageways for a gas flow continuously transports delayed-neutron emitters between said fuel regions to control reactivity and to remove volatile fission products.

3. The reactor of claim 1 wherein said core material is non-enriched uranium and spent fuel material having a form selected from the group consisting of powder, granules or porous annular pellets disposed within the interior space; upper and lower end caps sealed to the upper and lower ends; and at least one gas port disposed on the upper end cap or tubular cladding in fluid communication with the interior space.

4. The reactor of claim 1 having hardware such as in-core gamma and neutron detectors as well as fuel, delayed-neutron emitter and coolant flow measurement devices wherein real-time software instructions are utilizing for synthesis of the signals of said detectors into a 3-D power distribution of the core and the time-dependent power-to-signal conversion factor is determined from the previous values by a simple recurrent formula.

5. The compact reactor of claim 1 wherein a thermal core provides electrical power for several years and a central core serves as a neutron source for several hundred days.

6. The reactor of claim 5 wherein the core regions have passageways for gaseous propellant such as hydrogen, steam or noble gases heating or isotope extraction.

7. The reactor of claim 5 operable to produce a medical isotope, comprising: an accelerator for neutral particle production comprised of
(a) at least one centrally located target-distributed assembly consisted of a gas-filled cell or solid electrode array for neutral particle production,
in which the portion of the beam is recycling or an additional electrical field compensates for lost beam energy in internal targets,
(b) a direct energy converter that receives at least a portion of the kinetic energy of said charged particles, and stores it in the capacitance of the high-voltage sections of said target-distributed assembly to provide the charging electric energy to accelerate said beam,
(c) a cell positioned proximate the target chamber wherein the neutrons interact with a parent material to produce the radioisotope via fission or capture reaction.

8. A reactor of claim 1 wherein said accelerator is selected from the group consisting of D-T and electron accelerators wherein the wave model of observed relativistic phenomena is applied to study longitudinal and transverse effects in said accelerators.

9. The reactor of claim 5 wherein said accelerator has plurality of annular insulators are structured from materials that have high optical dielectric constant such as thorium oxide, in which said direct energy converters are arrays of fission electric cells with means for applying a high voltage to said post-accelerating sections and with a high vacuum wherein at least one of the fission electric cells of each array adapted to extract a beam of charged particles to produce energy.

10. The reactor of claim 5 wherein said accelerator comprising of a high voltage direct current power supply and a electromagnetic power supply and periodic undulating waveguide sections having a longitudinal dielectric sleeve, and means to obtain substantially continuous acceleration by applying said magnetic or fission energy to acceleration sections to post-accelerate and to control said beam.

11. The reactor of claim 5 wherein the fission electric cells comprising:
(a) at least two electrodes for collecting of charged particle having at least two well-defined energy groups, where the particles of first group have lower kinetic energy than the particles of second group,
(b) at least two current-carrying electrostatic grids for suppressing secondary electron emission, wherein first electrode positioned in said fission electric cells converts a first group of the charged particles to high electrical potential and has a high transparency to a second group of the charged particles, and second electrode is sufficiently thick to capture all positive charged particles or fission fragments while is essentially transparent to high-energy electrons,

12. The reactor of claim 1 to safely produce useful energy and to convert the nuclear waste into a usable fuel or isotopes comprising:
(a) a core wherein neutron feedback loops, steam generators or heat exchangers and gas waste separators are contained within the internal volume of said reactor,
(b) an external source of neutrons that controls an axial power distribution and quickly reacts to any fluctuations of the reactor parameters,
(c) a low-decontamination technique for processing spent fuel such as gas-phase extraction or dry solid fuel reprocessing, a Purex process to separate uranium, plutonium and neptunium, and further a Truex process to separate americium, curium and rare earth elements. Of the several processes, the FLUOREX method (hybrid process of fluoride volatility and solvent extraction works best in uranium based systems such as the power and medical reactors.

13. The reactor of claim 5 for producing and extracting useful fission products generated in a sub-critical core, wherein the extraction system uses oxygen to strip MoO.sub.3 gas from uranium oxide and consists of a gas flow system coupled to the gas ports to evacuate the radioisotopes from the fuel/target and a recovery chamber to collect them.

14. The reactor of claim 5 comprising a target approximately sized as a fuel element of a core, wherein the target contains non-fissile material such as natural molybdenum or reusable low enriched uranium fuel material. Additional isotopes for cancer therapy or imaging technology such as I-131, I-125, Xe-133, Re-188 or Ga-68 could be activated.

15. The reactor of claim 5 wherein the neutron multiplying and reflecting material are used for a thermal or resonance neutron multiplication.

16. The reactor of claim 5, wherein the neutron source comprises at least two tritium ion sources with beam recycling in a close loop, and a deuterium gas target which interacts with the tritium ion beam to produce neutrons.
